(19) United States
(12) Patent Application Publication
(10) Pub. No.: US 2025/0225896 A1
(43) Pub. Date: Jul. 10, 2025

(54) IN-VEHICLE PROJECTION SYSTEM AND CONTROL METHOD OF IN-VEHICLE PROJECTION SYSTEM, AND VEHICLE

(71) Applicant: HONDA MOTOR CO., LTD., Minato-ku (JP)

(72) Inventors: Xiaomei Fan, Guangzhou (CN); Dongyu Jiang, Guangzhou (CN); Peiyao Hu, Guangzhou (CN)

(21) Appl. No.: 18/985,103

(22) Filed: Dec. 18, 2024

(30) Foreign Application Priority Data
Jan. 5, 2024 (CN) 202410021964.8

(51) Int. Cl. G09G 3/00; B60K 35/10; G06F 3/01; G06F 3/16

(52) U.S. Cl. CPC G09G 3/001; G06F 3/017; G06F 3/167; B60K 35/10; G06F 3/012; G09G 2354/00; G09G 2380/10

(57) ABSTRACT

The present invention provides in-vehicle projection system and control method therefor, and vehicle. The in-vehicle projection system includes: a control apparatus that receives a command from a user, acquire a display interface related to operation regarding the command, and determine position of the user in vehicle according to the command; and a projection apparatus that projects the display interface to predetermined region in the vehicle corresponding to the position of the user. The control apparatus starts to execute the operation regarding the command from the user, and the display interface displays process of the control apparatus executing the operation regarding the command from the user. Accordingly, by projecting the display interface related to the operation regarding the command issued by the user to suitable region visible to the user, the user intuitively sees execution process of the command, which increases the interestingness and improves user experience.

### CROSS-REFERENCE TO RELATED APPLICATION

Priority is claimed on Chinese Patent Application No. 202410021964.8, filed on Jan. 5, 2024, the contents of which are incorporated herein by reference.

### BACKGROUND OF THE INVENTION

### Field of the Invention

The present invention relates to a field of vehicle-mounted apparatus control, in particular to an in-vehicle projection system and a control method of in-vehicle projection system, and a vehicle.

### Description of Related Art

With the development of an automobile industry, an in-vehicle networking function is also evolving, and an in-vehicle entertainment apparatus and an in-vehicle component can be controlled by an operating system.

A control operation in the related art requires a user to manually touch a screen or press a button. However, a control performed by manually touching the screen or pressing the button is not user-friendly and is not conducive to driving safety for a driver in a driving process, and for a passenger sitting in a back seat, this control makes it difficult to control an entertainment operating system or an in-vehicle screen and makes the passenger feel bad.

With the development of a voice recognition technology, some control operations may be implemented by using a voice recognition function in a vehicle, for example, a function of controlling opening, switching, volume adjustment and the like of an entertainment system, which greatly improves user experience of the driver and the passenger, and is also more conducive to driving safety.

It should be noted that the above description of related art is only for a purpose of clearly and completely describing the technical solution of the present invention and facilitating the understanding of those skilled in the art. The above technical solutions cannot be considered as known to those skilled in the art merely because these solutions are described in the description of related art of the present invention.

### SUMMARY OF THE INVENTION

The inventor finds that all users in a vehicle can control an entertainment system through a control executed by a voice command, but due to a fact that only a result feedback regarding the voice command can be heard, a voice control process cannot be intuitively seen, interestingness is lacked. In addition, an adjustment result cannot be immediately confirmed sometimes, and therefore, when an adjustment error is caused by a voice recognition error, the control error cannot be discovered in time, and an intuitive feeling that the user is operating the entertainment system himself cannot be provided.

In order to solve at least one of problems in the related art, the present invention provides an in-vehicle projection system and a control method therefor, and a vehicle, which can enable a user to intuitively see a command execution process, increase the interestingness, and improve a user experience.

According to a first aspect of embodiments of the present invention, an in-vehicle projection system is provided. The in-vehicle projection system includes:
a control apparatus configured to receive a command from a user, acquire a display interface related to an operation regarding the command, and determine a position of the user in a vehicle according to the command; and
a projection apparatus configured to project the display interface to a predetermined region in the vehicle corresponding to the position of the user,
wherein the control apparatus starts to execute the operation regarding the command from the user, and the display interface displays a process of the control apparatus executing the operation regarding the command from the user.

Further, by projecting the display interface related to the operation regarding the command issued by the user to a suitable region visible to the user, the user intuitively sees an execution process of the command, which increases the interestingness, improves a user experience, and creates an intuitive feeling that the user is operating the interface himself.

According to a second aspect of the embodiments of the present invention, the display interface includes a first interface before executing the operation of the command, and/or a second interface in which operation of the command is executed, and/or a third interface in which a process from before executing the operation of the command until executing and completing the operation of the command.

Further, an interface showing a process of executing the command from the user is displayed to the user, so that the user can intuitively see the process of executing his or her command and see a change before and after adjustment, which can enable the user to have an immersive experience and improve a riding experience.

According to a third aspect of the embodiments of the present invention, the predetermined region includes at least one projection region, and a position of the projection region is determined based on the position of the user in the vehicle, or the position of the user in the vehicle and the number of users.

Further, the projection region is determined based on the position of the user, or the position of the user and the number of users, so that the projection region is matched with the user, and the user can intuitively see a projected picture, which is more humane.

According to a fourth aspect of the embodiments of the present invention, the position of the user includes a region where the user is located in the vehicle and/or a seat where the user is seated in the vehicle.

Further, the position of the user may be determined by the region where the user is located in the vehicle, such as a front row or a rear row, or may be determined by the seat where the user is seated in the vehicle, such as a seat on a right side of the rear row. In this way, the predetermined region can be set accordingly based on the position of the user, and can be set based on an actual need to meet a user's preference.

According to a fifth aspect of the embodiments of the present invention, the predetermined region includes a region in front of the region where the user is located in the vehicle and/or a region in front of the seat where the user is seated in the vehicle.

Further, the predetermined region may be determined based on a setting manner of the position of the user, may correspond to the region in the vehicle and be located in front of the region in the vehicle, or may correspond to a certain seat and be located in front of a certain seat. In this way, the predetermined region can be set based on the actual need to meet a user's preference.

According to a sixth aspect of the embodiments of the present invention, the predetermined region includes a plurality of projection regions, each of which corresponds to respective one of seats in the vehicle, and when the command is received from the user, the control apparatus determines a corresponding projection region based on a seat where the user is seated, and the projection apparatus projects the display interface to the corresponding projection region.

According to a seventh aspect of the embodiments of the present invention, the predetermined region includes a plurality of projection regions, an interior space of the vehicle is virtually divided into a plurality of divided regions, each of the divided regions corresponds to respective one of the projection regions, and when the command is received from the user, the control apparatus determines a corresponding projection region based on a divided region where the user is located, and the projection apparatus projects the display interface to the corresponding projection region.

Further, a solution is provided for the correspondence between the projection region and the seat or the divided region in the vehicle. The projection region can be set accordingly based on a user need and an actual condition, thereby satisfying the user need while simplifying the setting of the projection region as much as possible.

According to an eighth aspect of the embodiments of the present invention, the control apparatus further acquires a seat where the user is seated and/or the number of users in the divided region, and the projection apparatus adjusts a position of a projection region corresponding to the divided region according to the seat where the user is seated and/or the number of users in the divided region.

According to a ninth aspect of the embodiments of the present invention, the interior space of the vehicle is divided into the plurality of divided regions based on a position of the user and/or the number of users.

Further, the divided region can be obtained based on a current situation in the vehicle, such as the location of the user and the number of users in the vehicle, which provides a most optimized region division while allowing the user to intuitively view the display interface. For example, when there are passengers on both a left seat and a right seat of the rear row, the entire rear row may be used as a divided region, and the display interface is projected to the middle of the rear-row region, so that users on both the left seat and the right seat can see the display interface. When there are passengers on both the left seat and a middle seat in the rear row, the left seat and the middle seat in the rear row can also be used as a divided region, and a specific position of the display interface in the projection region can be set to be in front of the middle between the left seat and the middle seat. The specific position of the display interface in the projection region can also be adjusted based on the user need to better meet a personalized need of the user.

According to a tenth aspect of the embodiments of the present invention, the predetermined region includes at least one projection region, to which the projection apparatus simultaneously projects two or more display interfaces.

Further, different display interfaces can be simultaneously displayed in one projection region, and different user needs can also be met when the projection region is reasonably set.

The projection apparatus may also include at least one projection device including a three-dimensional projection device and/or a two-dimensional projection device.

Further, the projection device can select the two-dimensional projection device and/or the three-dimensional projection device based on an actual need or a need of the apparatus to expand applicability.

According to an eleventh aspect of the embodiments of the present invention, the command includes a voice command and/or a gesture command.

Further, by recognizing the voice command or the gesture command, needs of different groups can be met, and a service group of a product can be expanded.

According to a twelfth aspect of the embodiments of the present invention, the display interface includes an interface related to an in-vehicle entertainment apparatus, and the control apparatus acquires the interface related to the in-vehicle entertainment apparatus according to the command.

Further, the interface related to the in-vehicle entertainment apparatus is displayed in front of the user through projection, and a feeling that the user is operating the in-vehicle entertainment apparatus by himself/herself is created.

According to a thirteenth aspect of the embodiments of the present invention, the in-vehicle projection system further includes a mounting apparatus configured to movably and/or rotatably mount the projection apparatus, in which the projection apparatus controls the mounting apparatus to move and/or rotate according to the position of the user so as to project the display interface to the predetermined region.

Further, after the predetermined region is determined, the projection region of the projection apparatus is adjusted by the mounting apparatus, and projection at arbitrarily position in a whole vehicle region can be implemented by one projection apparatus, so that the projection region is more suitable for the user to view, and the riding experience of the user can be further improved.

According to a fourteenth aspect of the embodiments of the present invention, a specific projection position of the display interface in the predetermined region changes correspondingly based on a change in a line of sight of the user and/or a face orientation of the user, and/or,

the specific projection position of the display interface in the predetermined region is moved to another position based on an operation of the user.

Further, by controlling the specific projection position of the display interface in the predetermined region based on the line of sight, the face orientation, the operation and the like of the user, the display interface follows the line of sight of the user or the willingness of the user to display, so that the user can intuitively see the display interface regardless of the state, and the riding experience of the user is further improved. In addition, the display interface can be projected and displayed at a required position based on the operation of the user to meet the personalized need of the user.

According to a fifteenth aspect of the embodiments of the present invention, the display interface is projected to the predetermined region for a predetermined time, and when it is detected that the user inputs a second command to the display interface projected to the predetermined region within the predetermined time, a display interface for executing a process of an operation regarding the second command is displayed in the predetermined region.

Further, an execution process of the second command is displayed by detecting that the user inputs the second command to the display interface, so that the user can continuously view the execution process of the command without any sense of interruption, and the riding experience of the user can be further improved.

According to a sixteenth aspect of the embodiments of the present invention, the display interface provides a virtual character, and a process of the virtual character executing the operation regarding the command from the user is displayed in the display interface.

Further, the process of the virtual character executing the operation regarding the command from the user is displayed in the display interface, so that the virtual character is animated instead of just viewing the display interface boringly, which further increases the interestingness.

According to a seventeenth aspect of the embodiments of the present invention, when a plurality of commands is received from a plurality of users, the control apparatus projects, based on positions of the users, display interfaces corresponding to the commands from the users to predetermined regions corresponding to the positions of the users, or

when a plurality of commands is received from a plurality of users, the control apparatus projects a plurality of display interfaces corresponding to the commands from the plurality of users to at least one of predetermined regions corresponding to positions of the plurality of users.

Further, each user has an exclusive projection region, which can provide personalized correspondence and can meet different user needs even when there are a plurality of users. Certainly, display interfaces corresponding to a plurality of users may also be displayed in a same predetermined region according to the user need, so that different user needs can be met while the projection region is reasonably set.

According to an eighteenth aspect of the embodiments of the present invention, a method for controlling an in-vehicle projection system is provided. The method includes:
receiving a command from a user and acquiring a display interface related to an operation regarding the command;
determining a position of the user according to the command;
projecting the display interface to a predetermined region in a vehicle corresponding to the position of the user; and
executing the operation regarding the command from the user, in which the display interface displays a process of executing the operation regarding the command from the user.

According to a nineteenth aspect of the embodiments of the present invention, a vehicle including the in-vehicle projection system according to any one of aspects 1 to 17 is provided.

The present invention has the following beneficial effects: By projecting the display interface related to the operation regarding the command issued by the user to a suitable region visible to the user, the user intuitively sees an execution process of the command, which increases the interestingness and improves the user experience. The division of the projection region is determined based on the position of the user and/or the number of users in the vehicle, so that the personalized correspondence can be implemented while the user need is met, and the experience of the user in the vehicle is improved.

Embodiments of the present invention are disclosed in detail with reference to the following description and drawings. It should be understood that embodiments of the present invention are not so limited in scope. Embodiments of the present invention include many changes, modifications, and equivalents within the scope of the appended claims.

Features described and/or illustrated for one embodiment may be used in a same or similar manner in one or more other embodiments, in combination with, or instead of, features in other embodiments.

It should be emphasized that terms “include/comprise/have” as used herein refer to the presence of a feature, an integer, or a component, but do not exclude the presence or addition of one or more other features, integers, or components.

### BRIEF DESCRIPTION OF THE DRAWINGS

The above and other objects, features and advantages of embodiments of the present invention will become more apparent from the following detailed description taken in conjunction with the drawings.

FIG. 1 is a schematic block diagram of an in-vehicle projection system according to Embodiment 1 of the present invention.

FIG. 2 is a schematic diagram showing projection regions of the in-vehicle projection system according to Embodiment 1 of the present invention.

FIG. 3 is a schematic diagram showing divided regions of the in-vehicle projection system according to Embodiment 1 of the present invention.

FIG. 4 is a schematic diagram showing projection positions of the in-vehicle projection system according to Embodiment 1 of the present invention.

FIG. 5 is another schematic diagram showing projection positions of the in-vehicle projection system according to Embodiment 1 of the present invention.

FIG. 6 is a schematic diagram showing a command execution process displayed on a display interface related to the in-vehicle projection system according to Embodiment 1 of the present invention.

FIG. 7 is a schematic diagram illustrating projection of more than two display interfaces to a projection region of the in-vehicle projection system according to Embodiment 1 of the present invention.

FIG. 8 is a flowchart of a method for controlling an in-vehicle projection system according to Embodiment 2 of the present invention.

FIG. 9 is a schematic block diagram of a control device of the in-vehicle projection system according to Embodiment 2 of the present invention.

### DETAILED DESCRIPTION OF THE INVENTION

The foregoing and other features of the present invention will become apparent from the following description with reference to the drawings. In the description and the drawings, specific embodiments of the present invention are specifically disclosed, which indicate some embodiments in which principles of the present invention can be adopted. It should be understood that the present invention is not limited to the described embodiments, and includes all modifications and equivalents falling within the scope of the appended claims.

An in-vehicle projection system and a control method therefor, and a vehicle according to embodiments of the present invention will be described below with reference to the drawings.

### Embodiment 1

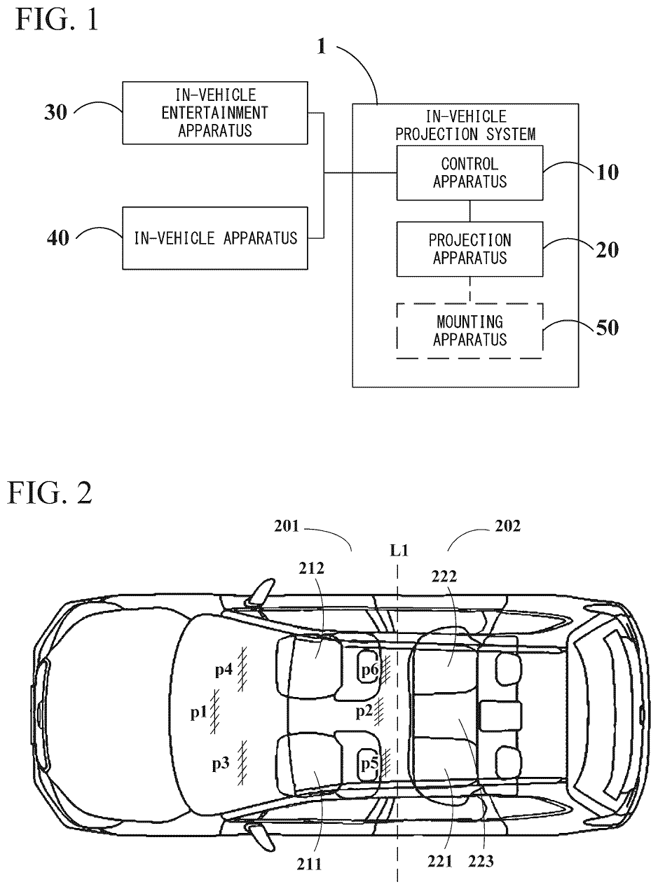

Embodiment 1 of the present invention provides an in-vehicle projection system. FIG. 1 is a schematic block diagram of the in-vehicle projection system according to Embodiment 1 of the present invention.

As shown in FIG. 1, the in-vehicle projection system 1 includes a control apparatus 10 and a projection apparatus 20. The control apparatus 10 is used to receive a command from a user, acquire a display interface related to an operation regarding the command, and determine a position of the user in a vehicle according to the command. The projection apparatus 20 is used to project the display interface to a predetermined region corresponding to the position of the user. The control apparatus 10 executes the operation regarding the command from the user. The display interface displays a process of the control apparatus 10 executing the operation regarding the command from the user.

Accordingly, by projecting the display interface related to the operation regarding the command from the user to a suitable region visible to the user, the user can intuitively see an execution process of the command, which increases the interestingness, improves the user experience, and creates an intuitive feeling that the user is operating the interface himself.

In this embodiment of the present invention, the command from the user may be a voice command or a gesture command. For example, the voice command from the user may be recognized by a voice recognition chip, or the gesture command from the user may be recognized by an image recognition chip after a gesture of the user is captured by an imaging device. In addition, the voice recognition chip and/or the image recognition chip may be integrated into the control apparatus 10, so that the control apparatus 10 can directly acquire the recognized command. The voice recognition chip and/or the image recognition chip may be integrated into a device such as a processor independent of the control apparatus 10, and the recognized command is sent to the control apparatus 10 through, for example, a wired or wireless communication link. A specific implementation method can refer to the related art, which is not limited in the embodiments of the present invention.

In this way, by recognizing the voice command or the gesture command, requirements of different people can be met, and a service group of a product can be expanded.

In this embodiment of the present invention, the control apparatus 10 may determine the position of the user in the vehicle according to the command. For example, when the user uses the voice command, the control apparatus 10 can detect the position of the user by a sound sensor disposed in the vehicle to determine the position of the user. Alternatively, the control apparatus 10 may obtain an image of the interior of the vehicle by an imaging device in the vehicle and determine the position of the user by analyzing the image. Alternatively, the control apparatus 10 may determine the position of the user by combining a seat sensor and the sound sensor in the vehicle. A specific implementation method can refer to the related art, which is not limited in the embodiments of the present invention.

In this embodiment of the present invention, the display interface may include a first interface before executing the operation regarding the command, and/or a second interface in which the operation of the command is executed and completed, and/or a third interface during a process from before executing the operation of the command to executing and completing the operation of the command.

In this way, the interface showing a process of executing the command from the user is displayed to the user, so that the user can intuitively see the process of executing his or her command and see a change before and after adjustment, which can enable the user to have an immersive experience and improve a riding experience.

For example, as shown in FIG. 1, in the vehicle, an in-vehicle entertainment apparatus 30 and an in-vehicle apparatus 40 may also be provided. The in-vehicle entertainment apparatus 30 and the in-vehicle apparatus 40 may be components of the in-vehicle projection system 1 or may be parts relatively independent of the in-vehicle projection system 1, and the in-vehicle entertainment apparatus 30 and the in-vehicle apparatus 40 may also be integrated together, which is not limited in this embodiment of the present invention. The control apparatus 10 may be integrated with the in-vehicle entertainment apparatus 30 or the in-vehicle apparatus 40, or may be disposed relatively independently, for example, the control apparatus 10 may be built into the in-vehicle entertainment apparatus 30, which is not limited in this embodiment of the present invention.

In some embodiments, the display interface may be an interface related to the in-vehicle entertainment apparatus 30 or a schematic interface related to the in-vehicle apparatus 40. For example, the in-vehicle entertainment apparatus 30 includes a music player, which may be a software application installed in an operating system or a hardware player. The display interface may be various interfaces that are preset in an application of the music player and interact with the user or may be a schematic interface representing the music player, for example, an interface of a rotating record player. Taking the application of the music player as an example, when the command from the user is, for example, “open music player”, the first interface may be, for example, an interface displaying an icon of the application of the music player, the second interface may be, for example, an interactive interface in which the application of the music player is currently opening, and the third interface may be, for example, all interfaces obtained in a process of switching from the interface displaying the icon of the music player to an interface in which the application of the music player is opened.

For another example, the in-vehicle apparatus 40 includes an air conditioner interface, and the display interface may be a sliding bar corresponding to a set temperature of an air conditioner, or a gradient bar of cold and warm colors, or an expression picture corresponding to the set temperature. Taking the sliding bar as an example, when the command from the user is, for example, “set the temperature in the vehicle to 24° C.”, the first interface may be an interface displaying a position of a sliding block on the sliding bar indicating a current temperature in the vehicle, the second interface may be an interface displaying a position of the sliding block on the sliding bar indicating 24° C., and the third interface may be an interface displaying the sliding block sliding on the sliding bar from the position indicating the current temperature in the vehicle to the position indicating 24° C.

In this embodiment of the present application, the projection apparatus 20 can project at least one of the first interface, the second interface, and the third interface. For example, the projection apparatus 20 may first project the first interface, then project the third interface, and then project the second interface, or may project only the second interface, or may project only the third interface, or may project only the first interface. The specific interface or interfaces to be projected can be set according to the command from the user, as long as the user can see an execution process and an execution result of the command after issuing the command. Certainly, the first interface, the second interface, and the third interface may be static interfaces frame by frame or dynamic interfaces, which is not limited herein.

In this way, the interface related to the execution of the command is displayed to the user for viewing, so that the user can obtain the immersive experience, and the riding experience is improved.

Projection regions for the display interface will be described below.

FIG. 2 is a schematic diagram showing projection regions of the in-vehicle projection system according to Embodiment 1 of the present invention.

As shown in FIG. 2, taking a case where two rows of seats are placed in the vehicle as an example, an interior space of the vehicle may be virtually divided into a plurality of divided regions, for example, divided into a front-row region 201 and a rear-row region 202 by a dotted line L1. The interior space of the vehicle may also be divided according to different seats, for example, a driver's seat 211, a co-driver's seat 212, a rear-row left seat 221, a rear-row right seat 222, and a rear-row middle seat 223. The divided region may be specifically customized by the user based on a user need. Several region division modes may be preset in the system, and the user may select them based on the requirement. Specific setting for the divided region are not limited in the embodiments of the present invention.

In this embodiment of the present invention, a direction parallel to a length direction of the vehicle is referred to as a “front-rear direction”, a direction parallel to a height direction of the vehicle is referred to as an “up-down direction”, and a direction parallel to a width direction of the vehicle is referred to as a “left-right direction”.

In addition, this embodiment of the present invention is described by taking a case where two rows of seats are placed in the vehicle as an example, but those skilled in the art should understand that for a case where other numbers of seats are placed in the vehicle, the interior space of the vehicle can be divided by analogy. This embodiment of the present invention may also be applied to a case where other numbers of seats are placed in the vehicle, which will not be repeated in the following embodiments.

In this embodiment of the present invention, the position of the user may include a region where the user is located in the vehicle and/or a seat where the user is seated in the vehicle. For example, as shown in FIG. 2, it may be determined that the user is located in the front-row region 201 according to the command issued by the user, or it may be determined that the user is located in the rear-row left seat 221 according to the command issued by the user.

In this embodiment of the present invention, the predetermined region may include a region in front of the region where the user is located in the vehicle and/or a region in front of the seat where the user is seated in the vehicle. For example, as shown in FIG. 2, when it is determined that the user is located in the rear-row region 202, the display interface may be projected to the front of the rear-row region 202, for example, onto backrests of seats in the front row. For another example, when it is determined that the user is located in the co-driver's seat 212, the display interface may be projected to the front of the co-driver's seat 212, for example, onto a front windshield or onto a road surface in front of the vehicle. Alternatively, the display interface may be projected, by a holographic projection manner, to the air in front of a region where the user is located, so that the user can see the display interface within his or her line of sight.

In this way, the projection region is determined based on the position of the user, or the position of the user and the number of users, so that the projection region is matched with the user, and the user can intuitively see the projected picture.

In addition, the position of the user may be determined by the region where the user is located in the vehicle, such as a front row or a rear row, or may be determined by the seat where the user is seated in the vehicle, such as a seat on a right side of the rear row. In this way, the predetermined region can be set accordingly based on the position of the user, and can be set based on an actual need to meet a user's preferences.

In some embodiments, the control apparatus 10 may determine the region where the user is located in the vehicle according to the received command, and the projection apparatus 20 projects the display interface to the front of the region where the user is located.

As shown in FIG. 2, for example, when a user located in the driver's seat 211 or the co-driver's seat 212 issues a command, the control apparatus 10 determines, according to the received command, that the user is in the front-row region 201, and the projection apparatus 20 projects the display interface to the front of the front-row region 201, for example, to the front-row projection region p1. The front-row projection region p1 is located, for example, in a middle position in front of the front windshield or in the air in front of the seats in the front row.

For another example, when a user located in the rear-row left seat 221, the rear-row right seat 222, or the rear-row middle seat 223 issues a command, the control apparatus 10 determines, according to the received command, that the user is in the rear-row region 202, and the projection apparatus 20 projects the display interface to the front of the rear-row region 202, for example, to the rear-row projection region p2. The rear-row projection region p2 is located, for example, in a middle position of the backrests of two front-row seats.

In some embodiments, the control apparatus 10 may determine the seat where the user is seated in the vehicle according to the received command, and the projection apparatus 20 projects the display interface to the front of the seat where the user is seated.

As shown in FIG. 2, for example, when the control apparatus 10 determines, according to the received command, that the command is issued by the user located in the rear-row right seat 222, the projection apparatus 20 projects the display interface to a projection region p6 in front of the rear-row right seat 222. In addition, the driver's seat 211 corresponds to a projection region p3, the co-driver's seat 212 corresponds to a projection region p4, the rear-row left seat 221 corresponds to a projection region p5, and the rear-row middle seat 223 corresponds to the projection region p2.

In this embodiment of the present invention, the predetermined region may include at least one projection region. For example, as shown in FIG. 2, the predetermined region may include the projection region p1 or the projection regions p1 to p6.

In some embodiments, a position of the projection region is determined based on the position of the user in the vehicle, or the position of the user in the vehicle and the number of users. For example, when the user in the vehicle is located in the front-row region 201, the projection region p1 may be determined as a projection position of the display interface. For another example, when there are two users in the front-row region 201, the projection regions p3 and p4 may be determined as the projection position of the display interface.

In some embodiments, each of the projection regions may correspond to respective one of seats in the vehicle. When the command is received from the user, the control apparatus 10 determines a corresponding projection region based on the seat where the user is seated, and the projection apparatus 20 projects the display interface to the corresponding projection region. For example, as shown in FIG. 2, each of the projection regions corresponds to respective one of seats in the vehicle.

The driver's seat 211 corresponds to the projection region p3, the co-driver's seat 212 corresponds to the projection region p4, the rear-row left seat 221 corresponds to the projection region p5, the rear-row right seat 222 corresponds to the projection region p6, and the rear-row middle seat 223 corresponds to the projection region p2. When the command is received from the user, the control apparatus 10 may determine, according to the command from the user, the seat where the user is seated, for example, the rear-row left seat 221, and determine that the corresponding projection region is the projection region p5, and the projection apparatus 20 projects the display interface to the projection region p5.

For example, the predetermined region to which the projection apparatus 20 projects the display interface may include a plurality of projection regions corresponding to the seats in the vehicle. The control apparatus 10 can acquire the number of users in the vehicle and the seat where the user is seated in the vehicle, and the projection apparatus 20 determines the number of projection regions according to the number of users in the vehicle, and projects the display interface to the corresponding projection region according to the seat where the user is seated in the vehicle.

As shown in FIG. 2, for example, the projection apparatus 20 can project the display interface to the regions p2 to p6 corresponding to the seats in the vehicle. For example, the control apparatus 10 acquires a fact that there are three users located in the driver's seat 211, the co-driver's seat 212, and the rear-row left seat 221 in the vehicle, respectively. The projection apparatus 20 can determine that the display interface needs to be projected to three projection regions, which are the projection region p3 corresponding to the driver's seat 211, the projection region p4 corresponding to the co-driver's seat 212, and the projection region p5 corresponding to the rear-row left seat 221, and project the display interface to these projection regions. Similarly, the driver's seat 211 and the co-driver's seat 212 may be made to correspond to one projection region, that is, the projection region p1, the rear-row left seat 221 may be made to correspond to the projection region p5 and the projection region may be specifically set based on the actual need of the user or may be specifically customized.

In this way, the display interface is projected to a viewable region for each user in the vehicle, so that the setting of the projection region is more humane, thereby allowing each user to feel involved and improving the riding experience.

For example, the predetermined region to which the projection apparatus 20 projects the display interface may include a plurality of projection regions corresponding to the plurality of divided regions divided in the vehicle, the control apparatus 10 can acquire a divided region where the user is located in the vehicle, and the projection apparatus projects the display interface to the corresponding projection region according to the divided region where the user is located.

As shown in FIG. 2, for example, the plurality of divided regions divided in the vehicle includes the front-row region 201 and the rear-row region 202. The projection region to which the projection apparatus 20 projects the display interface includes the front-row projection region p1 corresponding to the front-row region 201 and the rear-row projection region p2 corresponding to the rear-row region 202. The display interface is projected to the front-row projection region p1 or the rear-row projection region p2 according to whether the user is located in the front-row region 201 or the rear-row region 202. For example, when the control apparatus 10 determines that all users in the vehicle are located in the front-row region 201, the projection apparatus 20 projects the display interface to the front-row projection region p1 corresponding to the front-row region 201. In addition, when the control apparatus 10 determines that all users in the vehicle are located in the rear-row region 202, and the projection apparatus 20 projects the display interface to the rear-row projection region p2 corresponding to the rear-row region 202. In addition, when the control apparatus 10 determines that there are users in both the front-row region 201 and the rear-row region 202, the projection apparatus 20 projects the display interface to both the front-row projection region p1 and the rear-row projection region p2.

In this way, the display interface is projected to the region where all users are located, so that all users can see a control process of the command, and the riding experience is improved.

In addition, since the projection region can be correspondingly set based on the user need and an actual situation, the setting of the projection region can be simplified as much as possible while meeting the user need.

In some embodiments, the control apparatus 10 may further acquire a seat where the user is seated and/or the number of users in the divided region, and the projection apparatus 20 adjusts the position of the projection region corresponding to the divided region according to the seat where the user is seated and/or the number of users in the divided region.

As shown in FIG. 2, for example, when the control apparatus 10 acquires a fact that there is one user in the rear-row left seat 221 of the rear-row region 202, the projection apparatus 20 may move the projection region p2 corresponding to the rear-row region 202 to the front of the rear-row left seat 221, for example, move the projection region p2 to a position of the projection region p5. Alternatively, when the projection region of the projection apparatus 20 includes the projection regions p2 and p5, the projection apparatus 20 may select to project the display interface to the projection region p5. For another example, when the control apparatus 10 acquires a fact that there are two users in the rear-row region 202 who are respectively located in the rear-row left seat 221 and the rear-row middle seat 223, the projection apparatus 20 may move the projection region p2 corresponding to the rear-row region 202 toward the projection region p5, for example, to a position between the projection region p2 and the projection region p5, to facilitate viewing for the users located in the rear-row left seat 221.

For another example, during a driving process, when the control apparatus 10 determines that all users in the vehicle are located in the front-row region 201 and determines that there is only one user in the front-row region 201, it can be assumed that the command is issued by the user located in the driver's seat 211. In this case, the projection apparatus 20 can move the projection region to the front of the driver's seat 211, for example, move the projection region from p1 to p3. However, when the projection region of the projection apparatus 20 includes the projection regions p1 and p3, the projection apparatus 20 can choose to project the display interface to the projection region p3.

In this way, by determining the seat where the user is seated and/or the number of users in the divided region, the projection region is more reasonably set to meet a user need for viewing the interface, so that the user can more comfortably view the control process of the command, and unnecessary complex setting can be omitted, which is more humane and further improves the riding experience.

In addition, the divided region can be obtained based on a current situation in the vehicle, such as the location of the user and the number of users in the vehicle, which provides a most optimized region division while allowing the user to intuitively see the display interface. For example, when there are passengers on both a left seat and a right seat of the rear row, the entire rear row may be used as a divided region, and the display interface is projected to the middle of the rear-row region, so that users on both the left seat and the right seat can see the display interface.

In some embodiments, when a plurality of commands is received from a plurality of users, the control apparatus 10 projects, based on positions of the users, display interfaces corresponding to the commands from the users to respective predetermined regions corresponding to the positions of the users.

For example, as shown in FIG. 2, when a user sitting in the co-driver's seat 212 issues a command C1, and a user sitting in the rear-row middle seat 223 issues a command C2, the control apparatus 10 receives the command C1 and the command C2, determines that the command C1 comes from the user sitting in the co-driver's seat 212 according to the command C1 and that the command C2 comes from the user sitting in the rear-row middle seat 223 according to the command C2, and projects a display interface A2 corresponding to the command C1 to the predetermined region (for example, the projection region p4) corresponding to the co-driver's seat 212, and projects a display interface B1 corresponding to the command C2 to the predetermined region (for example, the projection region p2) corresponding to the rear-row middle seat 223.

In addition, the plurality of commands from the plurality of users may be received simultaneously, and the control apparatus 10 may display a plurality of display interfaces corresponding to the plurality of commands to corresponding predetermined regions simultaneously. For example, in the above example, the control apparatus 10 simultaneously receives the command C1 and the command C2, and the control apparatus 10 may simultaneously project the display interface A2 and the display interface B1 to the projection region p4 and the projection region p2 respectively. The control apparatus 10 may also display the plurality of display interfaces corresponding to the plurality of commands in one predetermined region. For example, in the above example, two users are located in the rear-row region. When the command C1 and the command C2 is received from the two users, the control apparatus 10 may simultaneously project the display interface A1 and the display interface B1 to the projection region p2 corresponding to the rear-row region, that is, a plurality of display interfaces may be simultaneously projected to one projection region.

It should be noted that “simultaneously” in this embodiment of the present invention does not need to be absolutely synchronized in time, and may refer to synchronization to a certain extent. For example, when there is a certain overlap in time between the issuance of the command C1 and the issuance of the command C2, a time when the control apparatus 10 receives the command C1 and the time when the control apparatus 10 receives the command C2 also overlap to a certain extent. The two commands may be considered to be simultaneous. For example, it is determined whether an overlapping time is within a predetermined time. When the overlapping time is within the predetermined time, the two commands are considered to be simultaneous. The predetermined time is, for example, 2 seconds, which is not limited in this embodiment of the present invention. In this case, the control apparatus 10 may project the display interface A1 and the display interface B1 to the projection region p4 and the projection region p2 respectively within a predetermined time interval.

In this way, each user has an exclusive projection region, which can provide personalized correspondence and can meet different user needs even when there are a plurality of users.

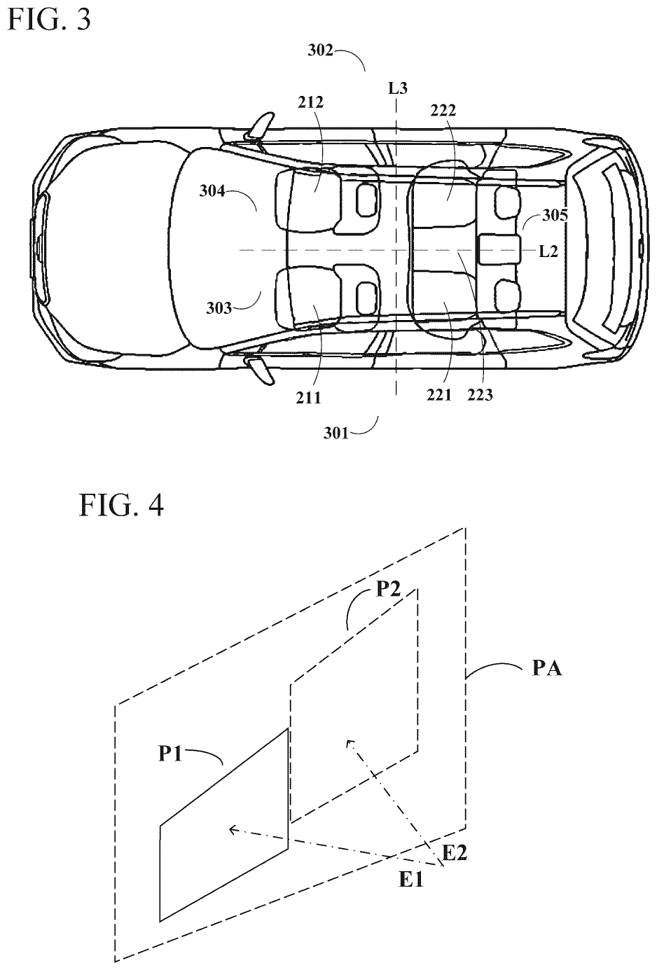

FIG. 3 is a schematic diagram showing divided regions of the in-vehicle projection system according to Embodiment 1 of the present invention.

The above description takes the example of dividing the interior space of the vehicle into the front-row region and the rear-row region along the front-rear direction, but the embodiments of the present invention are not limited thereto. The interior space of the vehicle may also be divided into the plurality of divided regions based on the position of the user and/or the number of users. For example, as shown in FIG. 3, when there are users in the driver's seat 211 and the left rear seat 221, the interior space of the vehicle may also be divided along the left-right direction, for example, into a left region 301 and a right region 302 along a dotted line L2; Alternatively, the interior space of the vehicle may be divided, along the dotted line L2 and a dotted line L3, into three divided regions including a divided region 303 centered on the driver's seat 211, a divided region 304 centered on the co-driver's seat 212, and a divided region 305 corresponding to three seats in the rear row. Alternatively, when there is only one user in the vehicle, a seat where the user is seated may be set as one divided region, and the other interior space of the vehicle may be set as another divided region. Specifically, how to set a plurality of divided regions may be predefined or customized by the user, which is not limited in this embodiment of the present invention.

In some embodiments, the projection apparatus 20 may include at least one projection device. For example, as shown in FIG. 2, six projection devices may be provided corresponding to the projection regions p2 to p6 corresponding to all seats, or two projection devices may be provided corresponding to the projection regions p1 and p2 corresponding to two divided regions (for example, the front-row region 201 and the rear-row region 202). In addition, only one projection device may be provided, and one projection device is used to form a plurality of projection interfaces.

In addition, the projection device may also be moved to project in a plurality regions. For example, as shown in FIG. 1, the in-vehicle projection system 1 may further include a mounting apparatus 50 that is used to mount the mounting apparatus 20 and can move and/or rotate. The projection apparatus 20 can control the mounting apparatus 50 to move according to the position of the user so as to project the display interface to a desired projection region. For example, a movable function of the mounting apparatus 50 may be implemented by a slide rail, a rotatable function of the mounting apparatus 50 may be implemented by a rotating gimbal, and a movement of the mounting apparatus 50 may also be implemented by other related technologies, which is not limited in the embodiments of the present invention.

In this way, the projection region of the projection apparatus is adjusted by the mounting apparatus, so that the projection region can be made more suitable for the user to view, and the riding experience of the user can be further improved.

In addition, the projection device according to this embodiment of the present invention may be a two-dimensional projection device. For example, the projection regions p5 and p6 may be set as back surfaces of backrests of the seats in the front row, and the back surfaces of the backrests of the seats in the front row are used as projection screens to project the display interface. The projection device may also be a three-dimensional projection device or a holographic projection device. For example, a projection device based on a Pepper's ghost principle may be used to project the display interface to a plurality of projection regions. Specific implementations of the two-dimensional projection device and the three-dimensional projection device can refer to the related art, which is not limited in the embodiments of the present invention.

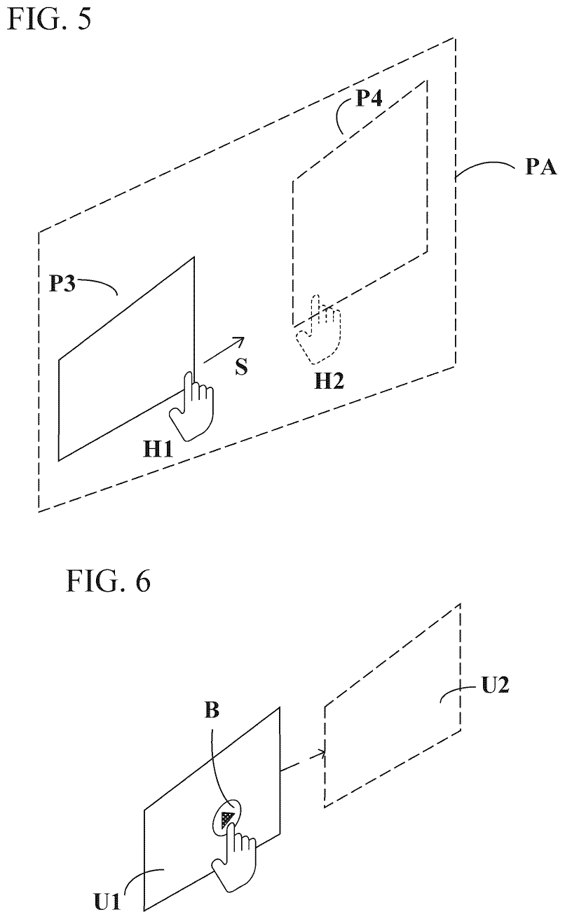

FIG. 4 and FIG. 5 are each a schematic diagram showing projection positions of the in-vehicle projection system according to Embodiment 1 of the present invention.

In some embodiments, a specific projection position of the display interface in the predetermined region changes correspondingly based on a change in a line of sight of the user and/or a face orientation of the user, and/or the specific projection position of the display interface in the predetermined region is moved to another position based on an operation of the user.

For example, as shown in FIG. 4, the line of sight of the user changes from a direction E1 to a direction E2, or the face orientation of the user changes from the direction E1 to the direction E2. The projection apparatus 20 can move the display interface in a predetermined region PA from a projection position P1 corresponding to the direction E1 to a projection position P2 corresponding to the direction E2.

For another example, as shown in FIG. 5, the user performs a sliding operation S on the display interface, a position of a finger may slide from a position H1 to a position H2, and the projection apparatus 20 may move the display interface in the predetermined region PA from a projection position P3 corresponding to the position H1 to a projection position P4 corresponding to a position H2.

In this way, the display interface can follow the line of sight of the user or the willingness of the user to further meet a current viewing need of the user and to further improve the riding experience of the user.

FIG. 6 is a schematic diagram showing a command execution process displayed on a display interface related to the in-vehicle projection system according to Embodiment 1 of the present invention.

In some embodiments, the display interface is projected to the predetermined region for a predetermined time, and when it is detected that the user inputs a second command to the display interface projected to the predetermined region within the predetermined time, a display interface for executing a process of an operation regarding the second command is displayed in the predetermined region.

For example, as shown in FIG. 6, a display interface U1 is projected to the predetermined region, and when it is detected that the user inputs another command to the display interface U1 within a predetermined time, for example, it is detected that the user clicks a play button B on the display interface U1 or a voice command for playback output by the user is detected, the control apparatus 10 can display a next playback interface U2 in the predetermined region. The above describes, by taking an example of detecting that the user clicks the button on the display interface, the user inputs the second command to the display interface, but the embodiments of the present invention are not limited thereto. For example, the fact that the user inputs the second command to the display interface may also be determined by recognizing a voice instruction from the user. An implementation of detecting that the command is input to the display interface can refer to the related art, which is not limited in the embodiments of the present invention.

In this way, an execution process of the second command is displayed by detecting that the user inputs the second command to the display interface, so that the user can continuously view the execution process of the command without any sense of interruption, and the riding experience of the user can be further improved.

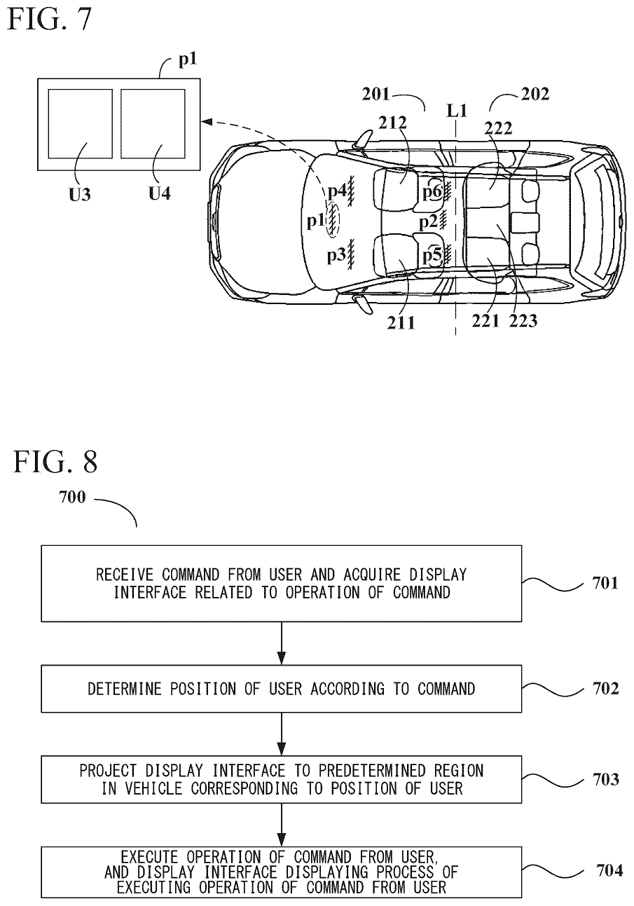

FIG. 7 is a schematic diagram illustrating projection of more than two display interfaces to a projection region of the in-vehicle projection system according to Embodiment 1 of the present invention.

In some embodiments, the projection apparatus 20 may simultaneously project at least two display interfaces to at least one projection region.

For example, as shown in FIG. 7, a display interface U3 and a display interface U4 can be projected simultaneously inside the projection region p1. The display interface U3 and the display interface U4 may be different display interfaces. The display interface U3 is, for example, a display interface obtained by performing an operation regarding a command issued by a user sitting in the driver's seat 211, and the display interface U4 is, for example, a display interface obtained by performing an operation regarding a command issued by a user sitting in the co-driver's seat 212. Of course, two different display interfaces corresponding to two commands issued by the same passenger may also be projected simultaneously inside one projection region p1. For example, the display interface U3 may be a display interface obtained for an operation regarding a command of adjusting the air conditioner issued by the passenger, and U4 may be a display interface obtained for an operation regarding a command of adjusting the seat issued by the same passenger. In this way, the same passenger can also adjust different functions at the same time, and can intuitively see a display interface for a command execution process at the same time, which is more humane.

Accordingly, different display interfaces can be simultaneously displayed in one projection region, and different user needs can also be met when the projection region is reasonably set.

In some embodiments, the display interface may also provide a virtual character, and a process of the virtual character executing the operation regarding the command from the user is displayed in the display interface. Accordingly, the interestingness is further increased.

It can be seen from the above embodiment that by projecting the display interface related to the operation regarding the command issued by the user to a suitable region visible to the user, the user intuitively sees the execution process of the command, which increases the interestingness and improves the user experience.

### Embodiment 2

Embodiment 2 of the present invention provides a control for controlling the in-vehicle projection system. FIG. 8 is a flowchart of the method for controlling the in-vehicle projection system according to Embodiment 2 of the present invention.

As shown in FIG. 8, a control method 700 according to the embodiment of the present invention includes:
step 701 of receiving a command from a user and acquiring a display interface related to an operation regarding the command; and
step 702 of determining a position of the user according to the command;
step 703 of projecting the display interface to a predetermined region in a vehicle corresponding to the position of the user; and
step 704 of executing an operation regarding the command from the user, and the display interface displaying a process of executing the operation regarding the command from the user.

Accordingly, by projecting the display interface related to the operation regarding the command issued by the user to a suitable region visible to the user, the user intuitively sees the execution process of the command, which increases the interestingness and improves the user experience.

In some embodiments, the region where the user is located in the vehicle may be determined according to the command in step 702, and the display interface is projected to the front of the region where the user is located in step 703. Alternatively, the seat where the user is seated in the vehicle may be determined according to the command in step 702, and the display interface is projected to the front of the seat where the user is seated in step 703.

In some embodiments, the predetermined region includes a plurality of projection regions, and each of the projection regions corresponds to respective one of the seats in the vehicle. When the command is received from the user in step 702, a corresponding projection region is determined based on the seat where the user is seated, and the display interface is projected to the corresponding projection region in step 703.

In some embodiments, the predetermined region may include a plurality of projection regions corresponding to the seats in the vehicle. The number of users in the vehicle and the seat where the user is seated in the vehicle may be acquired in step 702, and in step 703, the number of projection regions may be determined according to the number of users in the vehicle, and the display interface may be projected to the corresponding projection region according to the seat where the user is seated in the vehicle.

In some embodiments, the predetermined region includes a plurality of projection regions, the interior space of the vehicle is virtually divided into a plurality of divided regions, each of which corresponds to respective one of the projection regions. When the command is received from the user in step 702, a corresponding projection region is determined based on a divided region where the user is located, and the display interface is projected to the corresponding projection region in step 703.

In some embodiments, the predetermined region may include a plurality of projection regions corresponding to the plurality of divided regions divided in the vehicle. A divided region where the user is located in the vehicle may be acquired in step 702, and the display interface is projected to the corresponding projection region according to the divided region where the user is located in step 703.

In some embodiments, a seat where the user is seated and/or the number of users in the divided region may be acquired in step 702, and the position of the projection region corresponding to the divided region according to the seat where the user is seated and/or the number of users in the divided region in step 703.

In some embodiments, in step 703, a specific projection position of the display interface in the predetermined region changes correspondingly based on a change in a line of sight of the user and/or a face orientation of the user, and/or the specific projection position of the display interface in the predetermined region is moved to another position based on an operation of the user.

In some embodiments, in step 703, the display interface is projected to the predetermined region for a predetermined time, and when it is detected that the user inputs a second command to the display interface projected to the predetermined region within the predetermined time, a display interface for executing a process of an operation regarding the second command is displayed in the predetermined region.

In some embodiments, the display interface provides an virtual character, and a process of the virtual character executing the operation regarding the command from the user is displayed in the display interface.

In some embodiments, when a plurality of commands is received from a plurality of users in step 701, display interfaces corresponding to the commands from the users are projected, based on positions of the users, to respective predetermined regions corresponding to the positions of the users in step 703.

In this embodiment of the present invention, the implementation of the above steps can refer to a description for functions of the relevant apparatus in Embodiment 1, and will not be repeated here.

An embodiment of the present invention further provides a control device of the in-vehicle projection system, which corresponds to the control method described in the above embodiment. Functions of the control device can refer to a description of the relevant steps of the method for controlling the in-vehicle projection system in Embodiment 2, and repeated contents will not be described in detail.

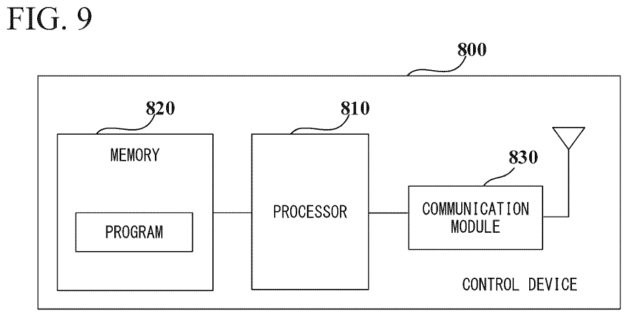

FIG. 9 is a schematic block diagram of the control device of the in-vehicle projection system according to Embodiment 2 of the present invention. As shown in FIG. 9, a control device 800 may include a processor 810 and a memory 820. The memory 820 is coupled to the processor 810. Notably, this figure is exemplary. Other types of structures may also be used to supplement or replace this structure to implement telecommunication functions or other functions.

In one embodiment, the processor 810 may receive a command from a user and acquire a display interface related to an operation regarding the command, determines a position of the user according to the command, and projects the display interface to a predetermined region according to the position of the user.

In this embodiment of the present invention, the implementation of functions of the processor 810 can refer to a description of the related steps of the method for controlling the in-vehicle projection system in Embodiment 2, and will not be repeated here.

The processor 810 is sometimes also referred to as a controller or an operation control, and may include a microprocessor or other processor devices and/or logic devices. The processor 810 receives an input and controls operations of components of the control device 800. In addition, the processor 810 may also be a processor of the in-vehicle projection system 1 in Embodiment 1, and implements control functions in the control apparatus 10 and the projection apparatus 20.

The memory 820 may be, for example, one or more of a buffer, a flash memory, a hard drive, a removable medium, a volatile memory, a non-volatile memory, or other suitable devices. The memory 820 can store various types of data and can also store a program for executing related information. In addition, the processor 810 can execute the program stored in the memory 820 to implement information storage or processing. Functions of other components are similar to those in the related art, and details are not described herein again. Components of the control device 800 can be implemented by dedicated hardware, firmware, software or a combination thereof without departing from the scope of the present invention.

In addition, as shown in FIG. 9, the control device 800 may further include a communication module 830. It should be noted that the control device 800 does not necessarily include all the components shown in FIG. 9. In addition, the control device 800 may further include a component not shown in FIG. 9, and reference may be made to related art.

It can be seen from the above embodiment that by projecting the display interface related to the operation regarding the command issued by the user to a suitable region visible to the user, the user intuitively sees the execution process of the command, which increases the interestingness and improves the user experience.

### Embodiment 3

Embodiment 3 of the present invention provides a vehicle including the in-vehicle projection system according to Embodiment 1. Functions of the in-vehicle projection system can refer to the description in Embodiment 1, and repeated contents will not be described in detail.

It can be seen from the above embodiment that by projecting the display interface related to the operation regarding the command issued by the user to a suitable region visible to the user, the user intuitively sees the execution process of the command, which increases the interestingness and improves the user experience.

Embodiments of the present invention have been described in detail above with reference to the drawings, indicating a manner in which principles of the present invention may be employed. However, it should be understood that implementations of the present invention are not limited to the above embodiments, but also include all changes, modifications, and equivalents without departing from the scope of the present invention.

What is claimed is:

1. An in-vehicle projection system, comprising:
a control apparatus configured to receive a command from a user, acquire a display interface related to an operation regarding the command, and determine a position of the user in a vehicle according to the command; and
a projection apparatus configured to project the display interface to a predetermined region in the vehicle corresponding to the position of the user, wherein
the control apparatus starts to execute the operation regarding the command from the user, and the display interface displays a process of the control apparatus executing the operation regarding the command from the user.

2. The in-vehicle projection system according to claim 1, wherein
the display interface includes a first interface before executing the operation of the command, and/or a second interface in which operation of the command is executed, and/or a third interface in which a process from before executing the operation of the command until executing and completing the operation of the command.

3. The in-vehicle projection system according to claim 1, wherein
the predetermined region includes at least one projection region, and a position of the projection region is determined based on the position of the user in the vehicle, or the position of the user in the vehicle and the number of users.

4. The in-vehicle projection system according to claim 1, wherein
the position of the user includes a region where the user is located in the vehicle and/or a seat where the user is seated in the vehicle.

5. The in-vehicle projection system according to claim 4, wherein
the predetermined region includes a region in front of the region where the user is located in the vehicle and/or a region in front of the seat where the user is seated in the vehicle.

6. The in-vehicle projection system according to claim 1, wherein
the predetermined region includes a plurality of projection regions, each of which corresponds to respective one of seats in the vehicle, and when the command is received from the user, the control apparatus determines a corresponding projection region based on a seat where the user is seated, and the projection apparatus projects the display interface to the corresponding projection region.

7. The in-vehicle projection system according to claim 1, wherein
the predetermined region includes a plurality of projection regions, an interior space of the vehicle is virtually divided into a plurality of divided regions, each of the divided regions corresponds to respective one of the projection regions, and when the command is received from the user, the control apparatus determines a corresponding projection region based on a divided region where the user is located, and the projection apparatus projects the display interface to the corresponding projection region.

8. The in-vehicle projection system according to claim 7, wherein
the control apparatus further acquires a seat where the user is seated and/or the number of users in the divided region, and
the projection apparatus adjusts a position of a projection region corresponding to the divided region according to the seat where the user is seated and/or the number of users in the divided region.

9. The in-vehicle projection system according to claim 7, wherein
the interior space of the vehicle is divided into the plurality of divided regions based on a position of the user and/or the number of users.

10. The in-vehicle projection system according to claim 1, wherein
the predetermined region includes at least one projection region to which the projection apparatus simultaneously projects two or more display interfaces.

11. The in-vehicle projection system according to claim 1, wherein
the command includes a voice command and/or a gesture command.

12. The in-vehicle projection system according to claim 1, wherein
the display interface includes an interface related to an in-vehicle entertainment apparatus, and the control apparatus acquires the interface related to the in-vehicle entertainment apparatus according to the command.

13. The in-vehicle projection system according to claim 1, further comprising a mounting apparatus configured to movably and/or rotatably mount the projection apparatus, wherein
the projection apparatus controls the mounting apparatus to move and/or rotate according to the position of the user so as to project the display interface to the predetermined region.

14. The in-vehicle projection system according to claim 1, wherein
a specific projection position of the display interface in the predetermined region changes correspondingly based on a change in a line of sight of the user and/or a face orientation of the user, and/or
the specific projection position of the display interface in the predetermined region is moved to another position based on an operation of the user.

15. The in-vehicle projection system according to claim 1, wherein
the display interface is projected to the predetermined region for a predetermined time, and when it is detected that the user inputs a second command to the display interface projected to the predetermined region within the predetermined time, a display interface for executing a process of an operation regarding the second command is displayed in the predetermined region.

16. The in-vehicle projection system according to claim 1, wherein
the display interface provides a virtual character, and a process of the virtual character executing the operation regarding the command from the user is displayed in the display interface.

17. The in-vehicle projection system according to claim 1, wherein
when a plurality of commands is received from a plurality of users, the control apparatus projects, based on positions of the users, display interfaces corresponding to the commands from the users to predetermined regions corresponding to the positions of the users, or
when a plurality of commands is received from a plurality of users, the control apparatus projects a plurality of display interfaces corresponding to the commands from the plurality of users to at least one of predetermined regions corresponding to positions of the plurality of users.

18. A method for controlling an in-vehicle projection system, comprising:
receiving a command from a user and acquiring a display interface related to an operation regarding the command;
determining a position of the user according to the command;
projecting the display interface to a predetermined region in a vehicle corresponding to the position of the user; and
executing the operation regarding the command from the user, wherein
the display interface displays a process of executing the operation regarding the command from the user.

19. A vehicle, comprising the in-vehicle projection system according to claim 1.
